(19) United States
(12) Patent Application Publication
(10) Pub. No.: US 2026/0228919 A1
(43) Pub. Date: Aug. 6, 2026

(54) COMPUTER SYSTEM, METHOD, AND PROGRAM

(71) Applicant: Sony Interactive Entertainment Inc., Tokyo (JP)

(72) Inventor: HIDEAKI IWAKI, Tokyo (JP)

(73) Assignee: Sony Interactive Entertainment Inc., Tokyo (JP)

(21) Appl. No.: 19/576,677

(22) Filed: Mar. 24, 2026

Related U.S. Application Data
(63) Continuation of application No. PCT/JP2023/034810, filed on Sep. 26, 2023.

(51) Int. Cl. G06T 7/80; G06T 7/246

(52) U.S. Cl. CPC G06T 7/80; G06T 7/248; G06T 2207/20221

(57) ABSTRACT

Systems and methods are provided. An example system fuse of first and second frame data, the first frame data being generated at a first interval, the second frame data including a plurality of subframe data each generated at an interval shorter than the first interval, the second frame data being generated at a second interval longer than the first interval, generate an optical flow between a reference time for at least one subframe data in the second frame data and a reference time for the first frame data based on a result of sensing of the space by a third sensor of which temporal resolution is higher than those of the first and second sensors, compensate a position of a sensing result included in the second frame based on the optical flow, and fuse the first frame data with the second frame data including the compensated position of the result.

### CROSS-REFERENCES TO RELATED APPLICATIONS

This application is a continuation of International Patent Application No. PCT/JP 2023/034810, filed on Sep. 26, 2023, the entire disclosure of which is incorporated herein by reference for all purposes.

### TECHNICAL FIELD

The present disclosure relates to a computer system, a method, and a program.

### BACKGROUND

Time-of-flight (ToF) sensors, which measure the distance on the basis of the time of flight of light, are used to acquire three-dimensional information regarding a subject, for example. The ToF sensors operate mainly by two methods: the direct ToF (dToF) method that involves measuring the difference in time between transmitted light and reflected light and the indirect ToF (iToF) method that involves measuring the distance by detecting differences in phase between transmitted light and accumulated reflected light. For example, JP 2022-101310A discloses a technology by which a ToF sensor is combined with a camera. The disclosed technology provides a distance measurement system that disposes a distance measurement sensor and an imaging sensor to generate range images of the subject, the system being arranged to perform coordinate calibration automatically and more easily.

### SUMMARY

According to one aspect of the present disclosure, there is provided a computer system including a memory in which to store a program code and a processor that performs an operation in accordance with the program code. The operation includes performing fusion of first frame data and second frame data, the first frame data being generated at a first interval by a first sensor through space sensing, the second frame data including a plurality of pieces of subframe data each generated at an interval shorter than the first interval by a second sensor through the space sensing, the second frame data as a whole being generated at a second interval longer than the first interval. The operation further includes generating an optical flow between a reference time for at least one subframe included in the second frame and a reference time for the first frame on the basis of a result of the space sensing by a third sensor of which temporal resolution is higher than that of the first sensor and that of the second sensor. The operation further includes compensating a position of the sensing result included in the second frame on the basis of the optical flow. Performing the fusion includes fusing the first frame data with the second frame data in which the position of the sensing result is compensated.

According to another aspect of the present disclosure, there is provided a method including, by an operation performed by a processor in accordance with a program code stored in a memory, performing fusion of first frame data and second frame data, the first frame data being generated at a first interval by a first sensor through space sensing, the second frame data including a plurality of pieces of subframe data each generated at an interval shorter than the first interval by a second sensor through the space sensing, the second frame data as a whole being generated at a second interval longer than the first interval, generating an optical flow between a reference time for at least one subframe included in the second frame and a reference time for the first frame on the basis of a result of the space sensing by a third sensor of which temporal resolution is higher than that of the first sensor and that of the second sensor, and compensating a position of the sensing result included in the second frame on the basis of the optical flow. Performing the fusion includes fusing the first frame data with the second frame data in which the position of the sensing result is compensated.

According to a further aspect of the present disclosure, there is provided a program in accordance with which a processor performs an operation. The operation includes performing fusion of first frame data and second frame data, the first frame data being generated at a first interval by a first sensor through space sensing, the second frame data including a plurality of pieces of subframe data each generated at an interval shorter than the first interval by a second sensor through the space sensing, the second frame data as a whole being generated at a second interval longer than the first interval. The operation further includes generating an optical flow between a reference time for at least one subframe included in the second frame and a reference time for the first frame on the basis of a result of the space sensing by a third sensor of which temporal resolution is higher than that of the first sensor and that of the second sensor. The operation further includes compensating a position of the sensing result included in the second frame on the basis of the optical flow. Performing the fusion includes fusing the first frame data with the second frame data in which the position of the sensing result is compensated.

### BRIEF DESCRIPTION OF THE DRAWINGS

FIG. 1 is a diagram depicting an exemplary system embodying the present disclosure.

FIG. 2 is a timing chart indicating the exposure timings of a camera and sensors in the system depicted in FIG. 1.

FIG. 3 is a diagram for conceptually explaining a potential problem with the example in FIG. 2.

FIG. 4 is a flowchart depicting an exemplary process carried out by a first embodiment of the present disclosure.

FIG. 5 is a diagram for conceptually explaining the process in FIG. 4.

FIG. 6 is another diagram for conceptually explaining the process in FIG. 4.

FIG. 7 is a flowchart depicting an exemplary process carried out by a second embodiment of the present disclosure.

FIG. 8 is a diagram for conceptually explaining the process in FIG. 7.

FIG. 9 is another diagram for conceptually explaining the process in FIG. 7.

FIG. 10 is a flowchart depicting an exemplary process carried out by a third embodiment of the present disclosure.

FIG. 11 is a diagram for conceptually explaining the process in FIG. 10.

FIG. 12 is another diagram for conceptually explaining the process in FIG. 10.

### DETAILED DESCRIPTION

Combining the ToF sensor with the camera, as in the above-cited example, makes it possible, for example, to apply colors from RGB images to a point cloud obtained through distance measurement by the ToF sensor, to upsample distance measurement points with low spatial resolution on the basis of RGB images, or to fuse RGB images with distance measurement points typically through simultaneous localization and mapping (SLAM). However, since the ToF sensor and the camera have different frame intervals, the images and the results of distance measurement may not be correlated appropriately with each other.

It is therefore an object of the present disclosure to provide a computer system, a method, and a program for more appropriately correlating frames generated by space-sensing sensors (including cameras) having different frame intervals.

Some preferred embodiments of the present disclosure are described below with reference to the accompanying drawings. It is to be noted that, throughout the ensuing description and the drawings, constituent elements having substantially identical functions and configurations are represented by the same reference signs, and redundant explanations are omitted.

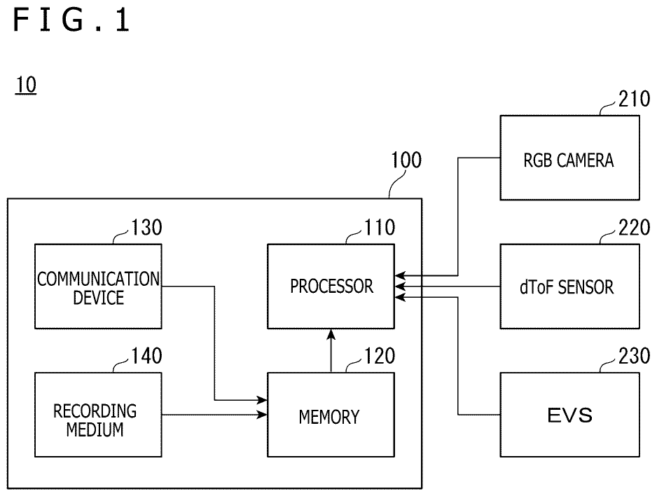

FIG. 1 s a diagram depicting a system embodying the present disclosure. In the illustrated example, a system 10 includes a computer 100, an RGB camera 210, a dToF sensor 220, and an event-based vision sensor (EVS) 230. The RGB camera 210 and the EVS 230 are arranged to have known positional relations to the dToF sensor 220. Images obtained by the RGB camera 210 and event information acquired by the EVS 230 can be correlated with the results of distance measurement by the dToF sensor 220.

The computer 100 is a game machine, a personal computer (PC), or a networked server, for example. The computer 100 includes a processor 110 and a memory 120. For example, the processor 110 includes processing circuits such as a central processing unit (CPU), a digital signal processor (DSP), an application specific integrated circuit (ASIC), and/or a field-programmable gate array (FPGA). Further, the memory 120 includes a storage device such as any one of various types of read only memories (ROMs), random access memories (RAMs), and/or hard disk drives (HDDs). The processor 110 operates according to a program code stored in the memory 120. The computer 100 further includes a communication device 130 and a recording medium 140. For example, a program code for causing the processor 110 to act as will be explained below may be received from an external device via the communication device 130, before being stored into the memory 120. Alternatively, the program code may be read from the recording medium 140 into the memory 120. The recording medium 140 includes a removable recording medium such as a semiconductor memory, a magnetic disk, an optical disk, or a magneto-optical disk, as well as a driver that drives the medium.

The RGB camera 210 includes an imaging element that acquire RGB images. The dToF sensor 220 includes a laser light source and a light-receiving element disposed for each of the pixels involved. The dToF sensor 220 outputs, for each pixel, the result of time difference measured between emittance of laser light from a light source and reception of the laser light as reflected light. The EVS 230, also called an event driven sensor (EDS), an event camera, or a dynamic vision sensor (DVS), includes a sensor array including sensors having light-receiving elements. When detecting a change in the intensity of incident light on a sensor, or more specifically, upon detection of a change in luminance on the surface of an object, the EVS 230 generates an event signal that includes a timestamp, sensor identification information, and polarity information regarding the luminance change. In the embodiments of the present disclosure to be discussed below, the RGB camera 210 and the dToF sensor 220 are examples of sensors that generate frame data through space sensing. The frame data is data that includes sensing results generated at predetermined intervals by the sensors. In the ensuing description, the frame data may simply be referred to as frames. The image data generated by the RGB camera 210 and the distance data generated by the dToF sensor 220 at each distance measurement point are examples of the frame data.

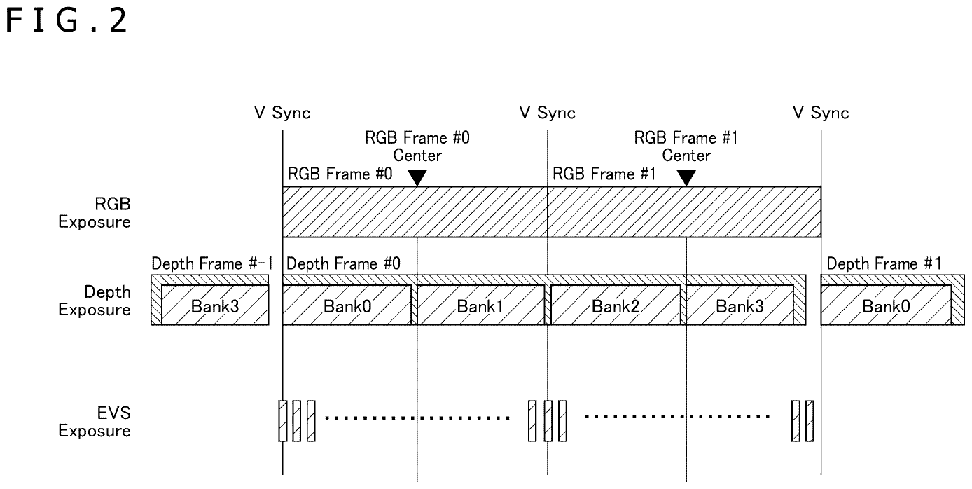

FIG. 2 is a timing chart indicating the exposure timings of the camera and the sensors in the system depicted in FIG. 1. It is to be noted that, while not making exposure in units of frames, the EVS 230 is nevertheless added to the exposure timing chart for purpose of explanation. The RGB camera 210 (RGB Exposure) performs exposure to generate an image with every vertical synchronization (V Sync). FIG. 2 indicates two consecutive RGB frames (RGB Frame #0 and RGB Frame #1). Meanwhile, the dToF sensor 220 (Depth Exposure) does not simultaneously measure distances to all distance measurement points but measures the distances successively by laser light emission and reception in groups called banks into which the distance measurement points are divided. In the illustrated example, the distance measurement points are divided into four banks (Bank 0, Bank 1, Bank 2, and Bank 3). The time in which to perform distance measurement once for each bank is indicated as frames of the dToF sensor 220 (part of Depth Frame #-1 and parts of Depth Frame #0 and Depth Frame #1). In this example, the distance data for each distance measurement point in each bank constitutes a plurality of pieces of subframe data constituting the frame data generated by the dToF sensor 220. The EVS 230 (EVS Exposure) generates event signals asynchronously with changes in light intensity. The temporal resolution of the EVS 230 is higher than that of the RGB camera 210 or that of the dToF sensor 220. That is, the interval at which the EVS 230 generates the event signal upon change in light intensity stemming from movements of the object is shorter than the exposure time of the RGB camera 210 or of the dToF sensor 220.

In the above example, the exposure time per frame of the dToF sensor 220 is longer than the exposure time per frame of the RGB camera 210, and is nearly as long as two frames. That is, the depth frames generated by the dToF sensor 220 are generated as a whole at an interval longer than the interval at which RGB frames are generated by the RGB camera 210. On the other hand, the individual banks (subframe data) included in the depth frames are each generated at an interval shorter than the interval at which the RGB frames are generated.

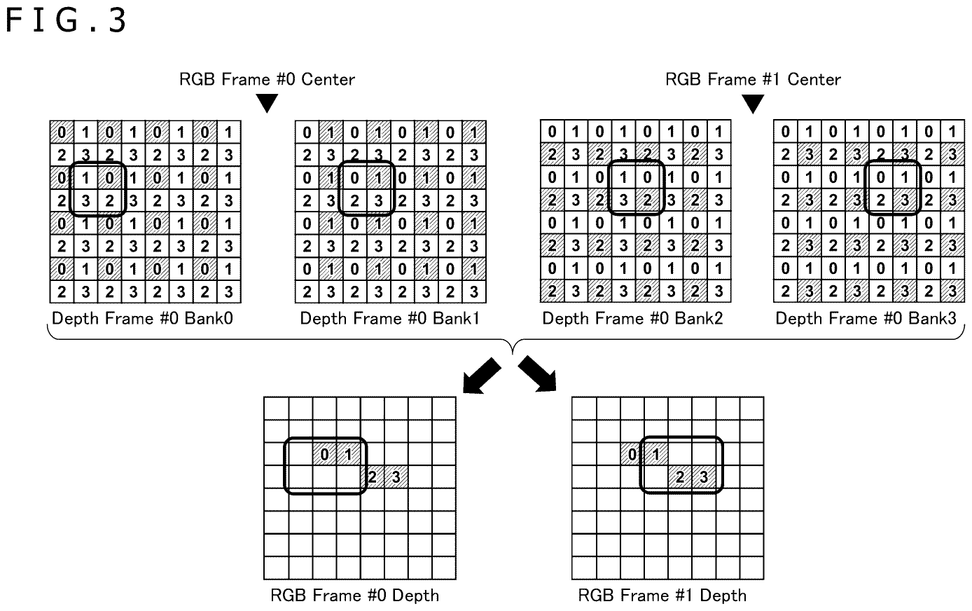

FIG. 3 is a diagram for conceptually explaining a potential problem with the example in FIG. 2. As explained earlier, distance measurement is performed successively at each distance measurement point in each of Bank 0, Bank 1, Bank 2, and Bank 3 in Depth Frame #0. As indicated in the timing chart of FIG. 2, RGB Frame #0 and RGB Frame #1 are both included in Depth Frame #0. A center time (Center) of exposure in RGB Frame #0 is positioned between the exposure times of Bank 0 and Bank 1 in Depth Frame #0. A center time (Center) of exposure in RGB Frame #1 is positioned between the exposure times of Bank 2 and Bank 3 in Depth Frame #0. Since the center time of the whole Depth Frame #0 is positioned approximately between the exposure times of Bank #1 and Bank #2, the center times of two RGB frames both diverge from the center time of the depth frame.

In a case where the center times of exposure are diverged as described above and where the results of distance measurement of the depth frames are fused with the RGB frame images, there may occur a growing divergence between a region where the subject existed in the RGB frame and a region where the depth position of the same subject was detected in the depth frame. As a result, the images and the results of distance measurement may not be correlated properly. Specifically, in RGB Frame #0 Depth with which the depth position in Depth Frame #0 is correlated, the region where the depth of the subject was detected diverges significantly to the right with respect to the region where the subject existed during the exposure time (surrounded by framework in the illustration, appearing larger than a region of the subject indicated likewise in each bank of the depth frame due to motion blur). Similarly, in RGB Frame #1 Depth with which the depth position in Depth Frame #0 is correlated, the region where the depth of the subject was detected diverges to the left with respect to the region where the subject existed during the exposure time.

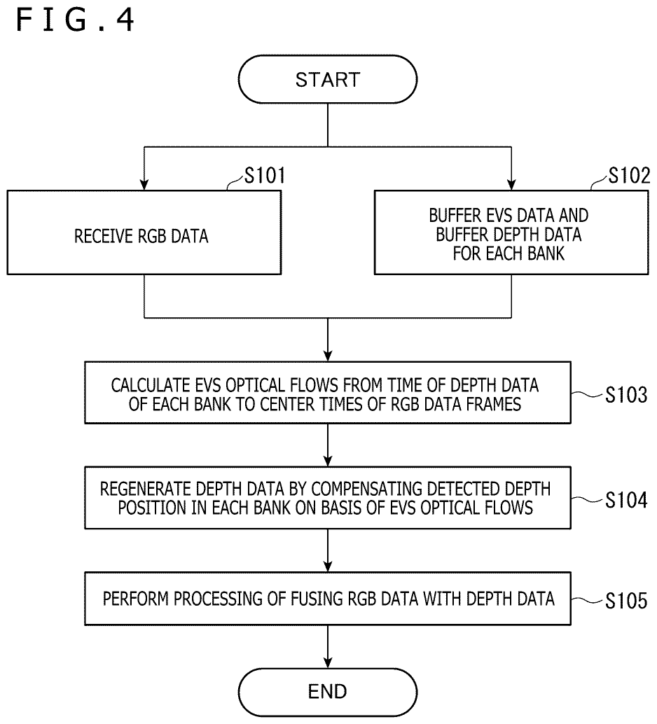

FIG. 4 is a flowchart depicting an exemplary process carried out by a first embodiment of the present disclosure. In the illustrated example, the processor 110 of the computer 100 receives RGB data acquired by the RGB camera 210 (step S101). The processor 110 also causes the memory 120 to buffer EVS data including an event signal acquired by the EVS 230 and to buffer, for each bank, depth data obtained by the dToF sensor 220 (step S102). Further, in fusing the RGB data with the depth data in units of frames, the processor 110 first calculates EVS optical flows (OF) between the time of the depth data of each bank and the center times of the RGB data frames (step S103). Since the temporal resolution of the EVS 230 is higher than that of the RGB camera 210 or that of the dToF sensor 220 as discussed above, it is possible to generate optical flows between the center times of the individual frames. The processor 110 regenerates the depth data by compensating the detected depth position in each bank on the basis of the optical flows generated from the EVS data (step S104). The processor 110 further performs processing of fusing the RGB data with the depth data regenerated in step S104 (step S105).

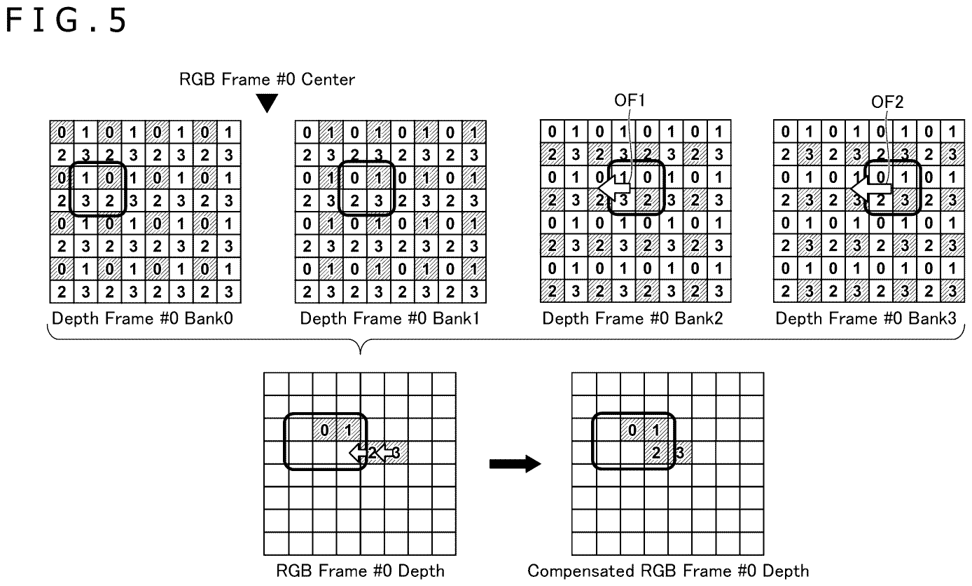

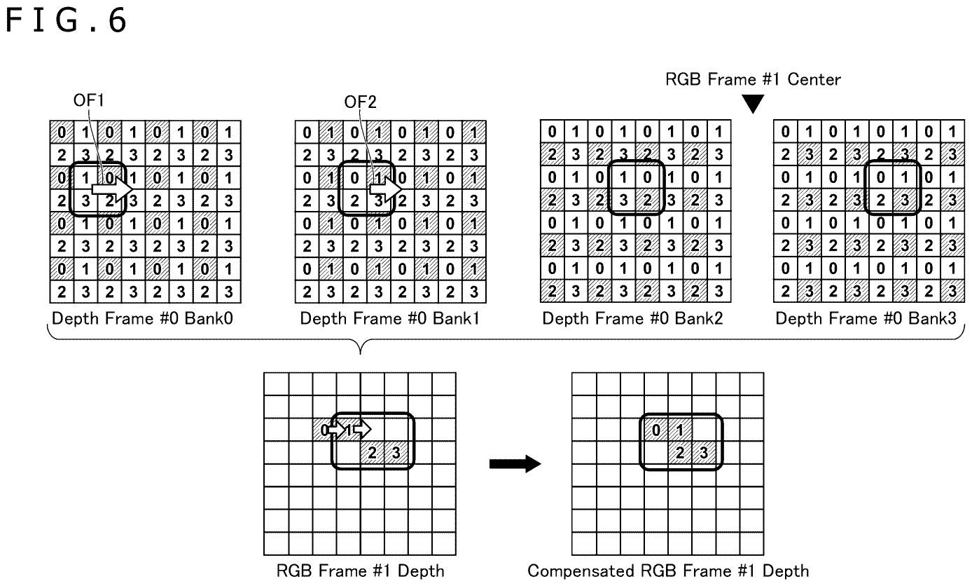

FIGS. 5 and 6 are diagrams for conceptually explaining the process in FIG. 4. FIG. 5 depicts an example in which the detected depth positions correlated with the RGB images of RGB Frame #0 in the example of FIG. 3 are compensated. In this embodiment, as discussed above in connection with step S103, the detected depth positions of Bank 2 and Bank 3 are compensated on the basis of optical flows generated from the EVS data, specifically an optical flow OF1 from the center time of Bank 2 in Depth Frame #0 to the center time (Center) of RGB Frame #0 and an optical flow OF2 from the center time of Bank 3 to the center time of RGB Frame #0. This compensation moves the detected depth positions in Bank 2 and Bank 3 in directions in which the divergence from the region where the subject existed in RGB Frame #0 is reduced. As a result, in RGB Frame #0 with which the compensated depth positions are correlated, the divergence between the region where the subject existed during the exposure time and the region where the depth position was detected is made smaller than in RGB Frame #0 Depth in the example of FIG. 3.

Meanwhile, FIG. 6 depicts an example in which the detected depth positions correlated with the RGB images of RGB frame #1 in the example of FIG. 3 are compensated. As in the above example of FIG. 5, the detected depth positions in Bank 0 and Bank 1 are compensated on the basis of the optical flow OF1 from the center time of Bank 0 in Depth Frame #0 to the center time (Center) of RGB Frame #1 and the optical flow OF2 from the center time of Bank 1 to the center time of RGB Frame #1. This compensation moves the detected depth positions in Bank 0 and Bank 1 in directions in which the divergence from the region where the subject existed in RGB Frame #1 is reduced. As a result, in RGB Frame #1 with which the compensated depth positions are correlated, the divergence between the region where the subject existed during the exposure time and the region where the depth position was detected is made smaller than in RGB Frame #1 Depth in the example of FIG. 3.

It is to be noted that, in the examples of FIGS. 5 and 6, the detected depth positions are compensated in a case where the volume of an optical flow exceeds a threshold. For example, although it is possible to generate the optical flows between the center times of Bank 0 and Bank 1 and the center time of the RGB frame in the example of FIG. 5 as well as between the center times of Bank 2 and Bank 3 and the center time of the RGB frame in the example of FIG. 6, no compensation is performed here because the magnitudes of the optical flows do not exceed the threshold. In such cases, the magnitudes of the optical flows may be compared with the threshold after they have been generated for all banks. For the banks of which the differences from the center time of the RGB frame are smaller than the threshold, no optical flow may be calculated.

A second embodiment of the present disclosure is explained next. In the above-described first embodiment, the detected depth positions in the banks are compensated on the basis of the optical flows in a manner reducing the divergence between the region of the subject in the RGB images and the detected depth positions. In the second embodiment, the divergence is reduced by selecting the banks suitable for being correlated with the RGB frame across the depth frames with reference to the center time of the RGB frame. Examples of this selection are, in FIG. 2, Depth Frame #-1 (the frame immediately preceding the depth frame corresponding to the RGB frame) and Depth Frame #1 (the frame immediately following the depth frame corresponding to the RGB frame). It is to be noted that, since no optical flows are used in the second embodiment, the EVS 230 need not be included in the system 10 depicted in FIG. 1.

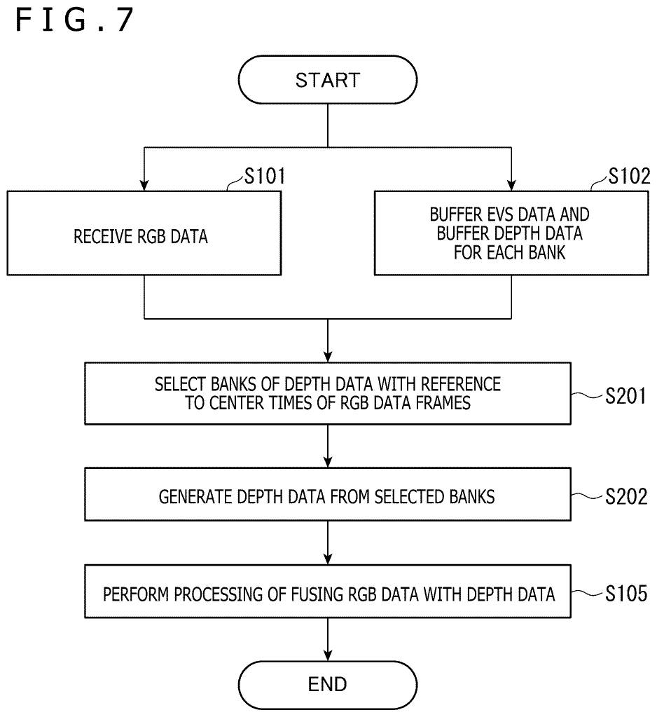

FIG. 7 is a flowchart depicting an exemplary process carried out by the second embodiment of the present disclosure. Subsequent to steps S101 and S102 (where EVS data is not needed) as in the example of FIG. 4, the processor 110 of the computer 100 selects the banks of the depth data with reference to the center times of the RGB data frames (step S201). At this point, regardless of the relation between the depth frames including the banks and the RGB frame, the banks with their center times closer to the center time of the RGB frame are selected, as in an example to be discussed later. Next, the depth data is generated using the banks selected in step S201 (step S202). Incidentally, since the depth data includes each of four types of banks (subframe data) in the example of FIG. 2, it is preferred in step S201 that each of the four banks (Bank 0, Bank 1, Bank 2, and Bank 3) be selected regardless of the different depth frames. The processor 110 further performs processing of fusing the RGB data with the depth data generated in step S202 (step S105).

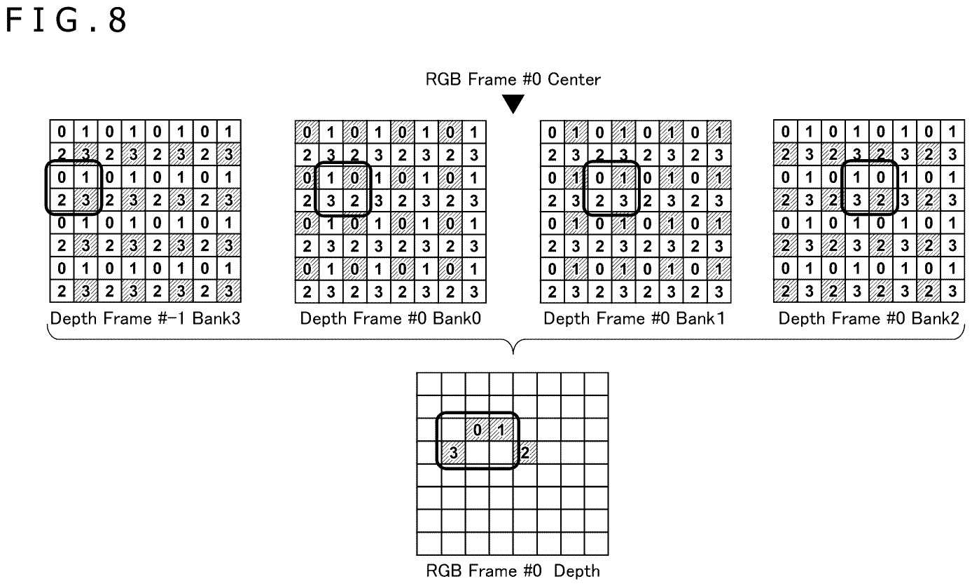

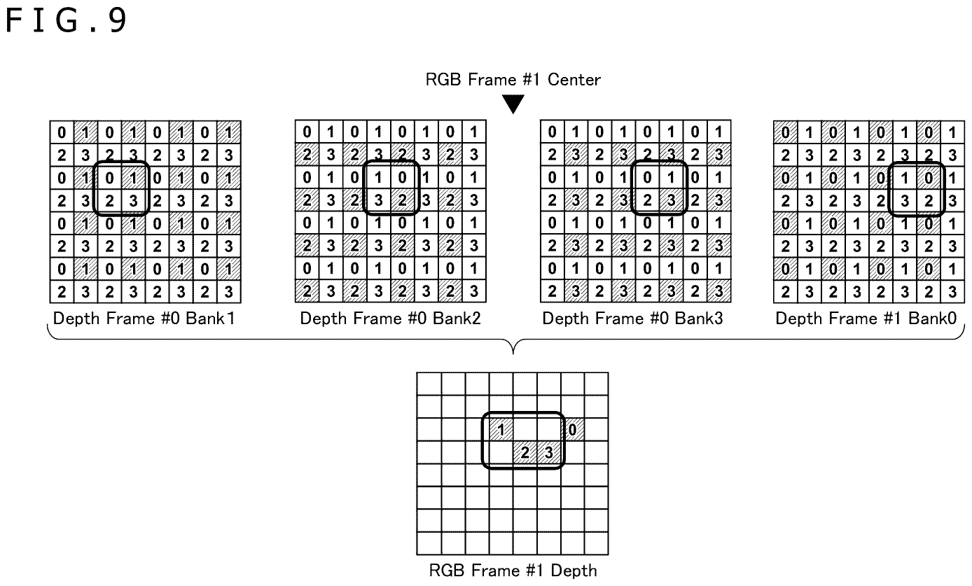

FIGS. 8 and 9 are diagrams for conceptually explaining the process in FIG. 7. FIG. 8 depicts an example in which the banks correlated with RGB Frame #0 in the example of FIG. 3 are selected across the depth frames. As explained above in connection with step S201, in the second embodiment, the banks with their center times closer to the center time of the RGB frame are selected regardless of the relation between the depth frames and the RGB frame. In the example of FIG. 8, Bank 3 of Depth frame #-1, and Bank 0, Bank 1, and Bank 2 of Depth Frame #0 are selected as the banks with their center times closer to the center time (Center) of RGB Frame #0. That is, the subframe data of the banks selected to generate the depth frames includes at least two pieces of subframe data (specifically, Bank 3 of Depth Frame #-1 and Bank 0 of Depth Frame #0) each included in a different frame. More specifically, since the center time of RGB Frame #0 precedes the center time of Depth Frame #0, Bank 3 included in the immediately preceding Depth Frame #-1 is selected. This type of selection, in the example of FIG. 3, causes Bank 3 of the immediately preceding Depth Frame #-1 instead of Bank 3 of Depth Frame #0, the farthest from the center time of RGB Frame #0, to be included in the depth data correlated with RGB Frame #0. Since the center time of Bank 3 in Depth Frame #-1 is closer to the center time of RGB Frame #0, there is less divergence than in the example of FIG. 3 between the region where the subject existed during the exposure time in RGB Frame #0 and the region where the depth position was detected.

On the other hand, FIG. 9 depicts an example in which the banks correlated with RGB Frame #1 in the example of FIG. 3 are selected across the depth frames. In the example of FIG. 9, Bank 1, Bank 2, and Bank 3 of Depth Frame #0 and Bank 3 of Depth Frame #1 are selected as the banks closer to the center time (Center) of RGB Frame #1. In this example, too, the subframe data of the banks selected with respect to the depth frames includes at least two pieces of subframe data (specifically, Bank 3 of Depth Frame #0 and Bank 0 of Depth Frame #1) each included in a different frame. More specifically, since the center time of RGB Frame #1 follows the center time of Dept Frame #0, Bank 0 included in the immediately following Depth Frame #1 is selected. This type of selection, in the example of FIG. 3, causes Bank 0 of the immediately following Depth Frame #1 instead of Bank 0 of Depth Frame #0, the farthest from the center time of RGB Frame #1, to be included in the depth data correlated with RGB Frame #1. Since the center time of Bank 0 in Depth Frame #1 is closer to the center time of RGB Frame #1, there is less divergence than in the example of FIG. 3 between the region where the subject existed during the exposure time in RGB Frame #1 and the region where the depth position was detected.

In the second embodiment, as indicated in the examples of FIGS. 8 and 9, banks in different combinations may be selected regarding two consecutive pieces of RGB frame data (RGB Frame #0 and RGB Frame #1). Incidentally, there may be cases in which, with reference to the center time of the RGB frame, there may be selection of the banks that are all included in the same depth frame or selection of the banks in the same combination regarding two consecutive pieces of RGB frame data.

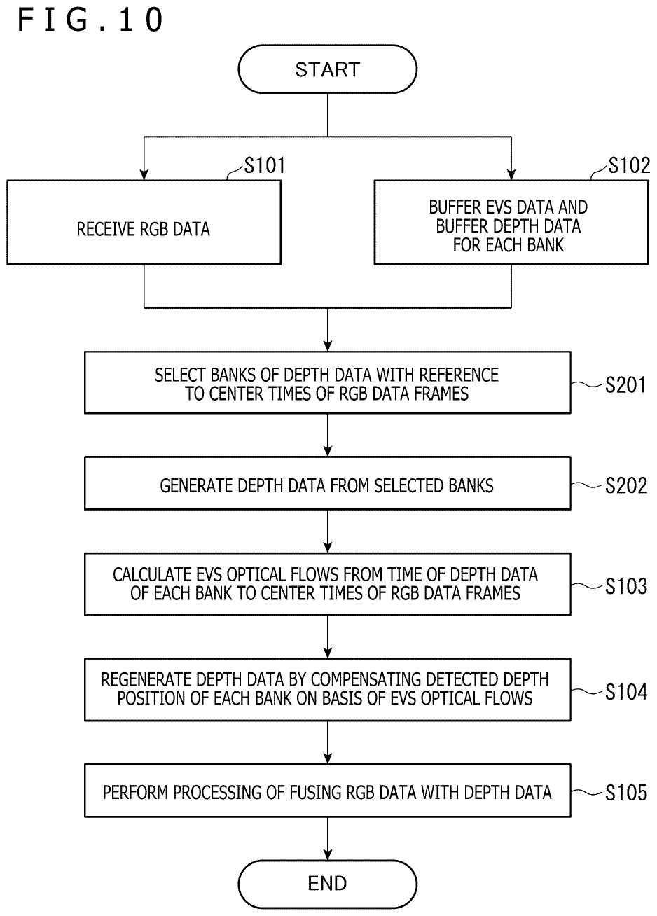

FIG. 10 is a flowchart depicting an exemplary process carried out by a third embodiment of the present disclosure. The second embodiment is explained below as an embodiment combining the first and second embodiments. The processor 110 of the computer 100 generates the depth data from the banks with their center times closer to the center time of the RGB frame by carrying out steps S101, S102, S201, and S202 as in the example of FIG. 7. Through execution of steps S103 and S104 as in the example of FIG. 4, the processor 110 further regenerates the depth data by compensating the detected depth positions on the basis of the EVS optical flows (OF) from the time of each bank of the depth data to the center times of the RGB data frames. Thereafter, the processor 110 performs processing of fusing the RGB data with the depth data regenerated in step S104 (step S105).

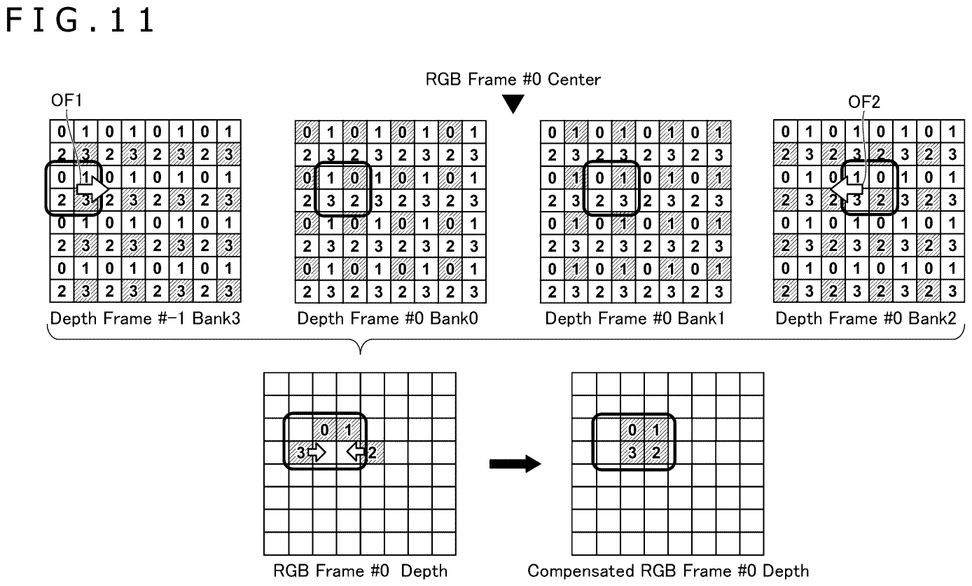

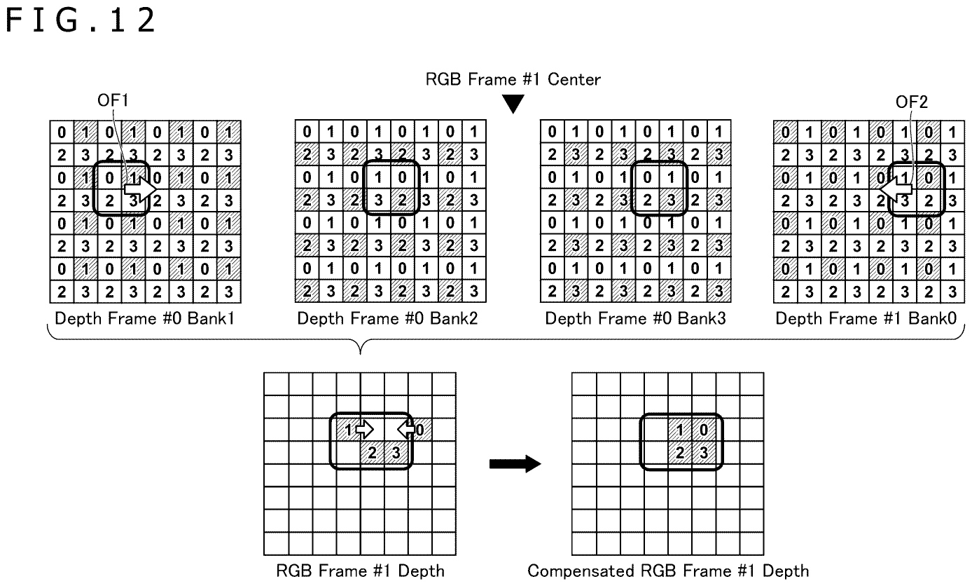

FIGS. 11 and 12 are diagrams for conceptually explaining the process in FIG. 10. FIG. 11 depicts an example in which the banks correlated with the RGB image of RGB Frame #0 in the example of FIG. 3 are selected across the depth frames, with the detected depth positions compensated. In the example of FIG. 11, as in the example of FIG. 8, Bank 3 of Depth Frame #-1 and Bank 0, Bank 1, and Bank 2 of Depth Frame #0 are selected as the banks closer to the center time (Center) of RGB Frame #0. Further, the detected depth position in each bank is compensated on the basis of the optical flows generated from the EVS data, specifically the optical flow OF1 from the center time of Bank 3 in Depth Frame #-1 to the center time (Center) of RGB Frame #0 and the optical flow OF2 from the center time of Bank 2 in Depth Frame #0 to the center time of RGB Frame #0. The processing above reduces the divergence between the region where the subject existed during the exposure time and the region where the depth position was detected in RGB Frame #0 with which the compensated depth positions are correlated.

Meanwhile, FIG. 12 depicts an example in which the banks correlated with the RGB image of RGB Frame #1 in the example of FIG. 3 are selected across the depth frames, with the detected depth positions compensated. In the example of FIG. 12, as in the example of FIG. 9, Bank 1, Bank 2, and Bank 3 of Depth Frame #0 and Bank 0 of Depth Frame #1 are selected as the banks closer to the center time (Center) of RGB Frame #1. Further, the detected depth position in each bank is compensated on the basis of the optical flows generated from the EVS data, specifically the optical flow OF1 from the center time of Bank 1 in Depth Frame #0 to the center time (Center) of RGB Frame #1 and the optical flow OF2 from the center time of Bank 0 in Depth Frame #1 to the center time of RGB Frame #1. The processing above reduces the divergence between the region where the subject existed during the exposure time and the region where the depth position was detected in RGB Frame #1 with which the compensated depth positions are correlated.

According to the third embodiment explained above, even when the imaging camera and the ToF sensor have different sampling rates, images and the results of distance measurement by the ToF sensor can more appropriately be correlated with each other by reducing the divergence between the region where the subject existed during the exposure time in the RGB frames and the region where the depth position was detected in the depth frames.

It is to be noted that FIGS. 3, 5, 6, 8, 9, 11, and 12 are schematic diagrams, so that the distance measurement points of the ToF sensor may not necessarily correspond to the RGB image pixels, and the divergence between the region where the subject existed and the region where the depth position was detected may not be recognized in units of pixels. Also, the distance measurement points of each bank of the ToF sensor may not necessarily be arrayed in a grid-like pattern. For example, the distance measurement points may be arranged linearly in the vertical or horizontal direction.

In the embodiments discussed above, an RGB camera is presented as the camera and a ToF sensor as the distance measurement sensor. Alternatively, another type of camera such as an infrared camera and another type of distance measurement sensor such as a light detection and ranging (LiDAR) sensor may be utilized. In the above-described embodiments, the images from the camera and the results of sensing by the distance measurement sensor are correlated with each other. Alternatively, as long as the relations of frame intervals and subframe intervals are similar to those in the above embodiments, the present disclosure may be embodied with any combination of sensors (including cameras). In other alternatives, the images from a plurality of cameras may be correlated with each other, or the results of detection by a plurality of sensors may be correlated with one another.

Further, in the above-described embodiments, the optical flows are generated from the EVS data by use of the EVS. Alternatively, the optical flows may be generated by use of other cameras or sensors having higher temporal resolution than that of the camera or the sensor of which the images or the results of detection are correlated. For example, the optical flows may be generated by use of a high frame rate camera in place of the EVS.

Further, in the above-described embodiments, the center time of exposure is presented as the reference time for the RGB frames and depth frames. Alternatively, a point in time other than the center time of exposure may be used as the reference time. For example, in a case where the RGB frame data is converted to high frame rate data through post-imaging processing, the reference time may be determined by the start and end times of the frame regarding each piece of the RGB frame data having been converted to high frame rate data. Further, as another example, when the RGB camera acquires RGB images by the rolling shutter method, it is possible to fuse the results of distance measurement of the depth frames by using, as the reference time, the center time of exposure for each of the lines included in the RGB frame data. In such cases, the reference time upon fusion of the RGB frame data and the results of measurement of the depth frames can be different from the center time of exposure upon imaging by the RGB camera.

What is claimed is:

1. A computer system comprising:
at least one processor; and
at least one memory storing instructions that, when executed by the at least one processor, cause the system to:
perform fusion of first frame data and second frame data, the first frame data being generated at a first interval by a first sensor through space sensing, the second frame data including a plurality of pieces of subframe data each generated at an interval shorter than the first interval by a second sensor through the space sensing, the second frame data as a whole being generated at a second interval longer than the first interval;
generate an optical flow between a reference time for at least one subframe data included in the second frame data and a reference time for the first frame data on a basis of a result of the space sensing by a third sensor of which temporal resolution is higher than that of the first sensor and that of the second sensor; and
compensate a position of a sensing result included in the second frame data on a basis of the optical flow,
wherein the fusion includes fusing the first frame data with the second frame data in which the position of the sensing result is compensated.

2. The computer system according to claim 1, wherein the position of the sensing result is compensated when a magnitude of the optical flow exceeds a threshold.

3. The computer system according to claim 1, wherein no optical flow is generated for subframe data where a difference between the reference time for the subframe data and the reference time for the first frame data is below a threshold.

4. The computer system according to claim 1, wherein the third sensor is an event-based vision sensor.

5. The computer system according to claim 4, wherein the third sensor is configured to generate an event signal upon detection of a change in light intensity.

6. The computer system according to claim 1, wherein the first sensor is a camera, and the second sensor is a distance measurement sensor.

7. The computer system according to claim 6, wherein an exposure time per frame of the second sensor is longer than an exposure time per frame of the first sensor.

8. The computer system according to claim 7, wherein the exposure time per frame of the second sensor is approximately twice the exposure time per frame of the first sensor.

9. A method comprising:
performing fusion of first frame data and second frame data, the first frame data being generated at a first interval by a first sensor through space sensing, the second frame data including a plurality of pieces of subframe data each generated at an interval shorter than the first interval by a second sensor through the space sensing, the second frame data as a whole being generated at a second interval longer than the first interval;
generating an optical flow between a reference time for at least one subframe data included in the second frame data and a reference time for the first frame data on a basis of a result of the space sensing by a third sensor of which temporal resolution is higher than that of the first sensor and that of the second sensor; and
compensating a position of a sensing result included in the second frame data on a basis of the optical flow,
wherein performing the fusion includes fusing the first frame data with the second frame data in which the position of the sensing result is compensated.

10. The method of claim 9, wherein the position of the sensing result is compensated when a magnitude of the optical flow exceeds a threshold.

11. The method of claim 9, wherein no optical flow is generated for subframe data where a difference between the reference time for the subframe data and the reference time for the first frame data is below a threshold.

12. The method of claim 9, wherein the third sensor is an event-based vision sensor.

13. The method of claim 12, wherein the third sensor is configured to generate an event signal upon detection of a change in light intensity.

14. The method of claim 9, wherein the first sensor is a camera, and the second sensor is a distance measurement sensor.

15. The method of claim 14, wherein an exposure time per frame of the second sensor is longer than an exposure time per frame of the first sensor.

16. The method of claim 15, wherein the exposure time per frame of the second sensor is approximately twice the exposure time per frame of the first sensor.

17. A non-transitory computer-readable medium storing computer-readable instructions that, when executed by a computer, cause the computer to perform operations comprising:
performing fusion of first frame data and second frame data, the first frame data being generated at a first interval by a first sensor through space sensing, the second frame data including a plurality of pieces of subframe data each generated at an interval shorter than the first interval by a second sensor through the space sensing, the second frame data as a whole being generated at a second interval longer than the first interval;
generating an optical flow between a reference time for at least one subframe data included in the second frame data and a reference time for the first frame data on a basis of a result of the space sensing by a third sensor of which temporal resolution is higher than that of the first sensor and that of the second sensor; and
compensating a position of a sensing result included in the second frame data on a basis of the optical flow,
wherein performing the fusion includes fusing the first frame data with the second frame data in which the position of the sensing result is compensated.

18. The non-transitory computer-readable medium of claim 17, wherein the position of the sensing result is compensated when a magnitude of the optical flow exceeds a threshold.

19. The non-transitory computer-readable medium of claim 17, wherein the third sensor is an event-based vision sensor.

20. The non-transitory computer-readable medium of claim 17, wherein the first sensor is a camera, and the second sensor is a distance measurement sensor.
